(19) United States
(12) Patent Application Publication
(10) Pub. No.: US 2006/0109261 A1
(43) Pub. Date: May 25, 2006

(54) Surface acoustic wave touch panel and system of the same

(75) Inventors: Yuan-Fang Chou, Hsinchu Hsien (TW); Keh-Long Hwu, Hsinchu (TW); Ching-Cheng Tien, Hsinchu (TW)

Correspondence Address: BIRCH STEWART KOLASCH & BIRCH, PO BOX 747, FALLS CHURCH, VA, 22040-0747, US

(73) Assignee: INDUSTRIAL TECHNOLOGY RESEARCH INSTITUTE, Hsinchu Hsien (TW)

(21) Appl. No.: 11/225,211

(22) Filed: Sep. 14, 2005

(30) Foreign Application Priority Data
Sep. 14, 2004 (TW) 093127719

(51) Int. Cl. G09G 5/00

(52) U.S. Cl. 345/177

(57) ABSTRACT

A surface acoustic wave touch panel and a system of the same are provided. The system includes the touch panel, an input/output (I/O) controlling unit, a detecting unit, and a signal processing unit. The touch panel includes a substrate on which at least one first emitter and at least one second emitter are provided on two adjacent edges thereof, and at least one first receiver and at least one second receiver are provided on the other two adjacent edges of the substrate. The I/O controlling unit controls the emitters to emit signals, and controls the detecting unit to pick up output signals from the receivers. The signal processing unit uses a neural network to determine an amplitude-reduction feature of any of the output signals so as to identify a position being touched on the touch panel. The touch panel is provided with high resolution and high throughput.

### FIELD OF THE INVENTION

The present invention relates to surface acoustic wave touch panels and systems of the same, and more particularly, to a surface acoustic wave touch panel composed of emitters and receivers made of piezoelectric films, and a system of the surface acoustic wave touch panel.

### BACKGROUND OF THE INVENTION

With the prevalence of computers, keyboards, and mice have become generally accepted input devices. However, since such conventional input devices are not space-economic when in use and need to be driven by complex programs, another type of input device has been developed and is named touch panel that is a combination of the input device and a display screen.

Touch panel is a user-friendly input device, which allows commands to be inputted simply by using a finger or touch pen to touch and select specific areas on the panel. As electronic products are developed to have compact size, light weight, and complex functions, a space for accommodating an input device in such electronic product is very limited. Accordingly, the touch panel is considered as the best choice for a human-machine interface, which is space-economic when in use and also provides the functions of keyboards and mice as well as allows user-friendly operations such as handwriting input. Touch panels are divided into types of resistance, capacitance, optic, and surface acoustic wave according to working principles thereof. The resistance-type touch panel has a drawback of low light transmittance and thus reduces brightness and contrast of the display screen. The capacitance-type touch panel is liable to changes in different temperature, humidity, and grounding conditions and thus has poor stability. The optic-type touch panel is limited on its resolution as depending on the number of infrared emitting/receiving pairs.

In light of the drawbacks for the above touch panels, there has been developed a surface acoustic wave touch panel. The current surface acoustic wave touch panel includes two different types according to a method for recognizing a touched position on the panel: one type composed of a single emitting transducer and a single receiving transducer for each coordinate, and the other type composed of an array of emitting transducers and an array of receiving transducers for each coordinate.

The foregoing surface acoustic wave touch panel is composed of a single emitting transducer and a single receiving transducer. The touch panel operates to excite surface waves from the emitting transducer and emit these surface waves via numerous reflecting gates at a specific angle relative to the panel edge, such that surface waves pass through different positions on the panel to be received by the receiving transducer at different time. Thereby, a touched position on the panel can be recognized according to a relation curve between transduction intensity of the received waves and time. FIG. 1A shows a structure of a surface acoustic wave touch panel system according to U.S. Pat. No. 4,644,400 using the mechanism of single emitting transducer and single receiving transducer. As shown in FIG. 1A, the surface acoustic wave touch panel system comprises a substrate 10; a pair of emitting transducers T1, T2 respectively on two sides of the substrate 10; a pair of receiving transducers R1, R2 respectively on the other two sides of the substrate 10; and a control system 11 electrically coupled to the pairs of emitting transducers T1, T2 and receiving transducers R1, R2. The transducers (T1, T2, R1, and R2) are respectively provided with reflecting gates G1, G2, G3, and G4 composed of a plurality of reflecting units (e1 to en) along corresponding paths P1, P2, P3, and P4 respectively.

The control system 11 creates emitting signals S1, S2 via an emitting transducer switch 11a. The emitting signals S1, S2 are transmitted to the corresponding emitting transducers T1, T2 respectively such that the emitting transducers T1, T2 create transmitting surface waves along the paths P1, P2 respectively.

For example of the transmitting surface waves created along the path P1, these surface waves are emitted via the reflecting gate G1 and separated into n parts at an angle of 45° relative to the path P1, and are then transmitted at an angle of 90° relative to the path P1 to the reflecting gate G2 opposite to the reflecting gate G1. The reflecting units e1 to en of the reflecting gate G2 deflect the n parts of surface waves emitted from the reflecting gate G1, and transmit the deflected surface waves to the receiving transducer R1 along the path P3. The receiving transducer R1 converts the received surface waves into a signal S3 and outputs the signal S3 to an amplitude detector 11b that is electrically connected to the control system 11. In addition, upon receiving the emitting signal S2 from the emitting transducer switch 11a, the emitting transducer T2 creates transmitting surface waves along the path P2. Surface waves are emitted via the reflecting gate G3 and separated into n parts at an angle of 45° relative to the path P2, and are then transmitted at an angle of 90° relative to the path P2 to the reflecting gate G4 opposite to the reflecting gate G3, such that the reflecting gate G4 deflects the n parts of surface waves emitted from the reflecting gate G3, and transmits the deflected surface waves to the receiving transducer R2 along the path P4. The receiving transducer R2 converts the received surface waves into a signal S4 and outputs the signal S4 to the amplitude detector 11b electrically connected to the control system 11.

Next, the amplitude detector 11b analyzes the signals S3, S4. Since the surface waves travel different distances to the receiving transducer R1 and reach at different time, the output signals S3 are as shown in FIG. 1B. Time t0 is the time when the surface waves reflected by the reflecting unit e1 of the reflecting gate G2 reach the receiving transducer R1, and time tn is the time when the surface waves reflected by the reflecting unit en of the reflecting gate G2 reach the receiving transducer R1, wherein the solid line indicates the output signals when the panel is not touched by a user. If assumed that point A1 in FIG. 1A indicates the touched position on the panel, a part of the surface waves reflected by the reflecting gate G1 is transmitted along a path Pv and passes through the point A1. Energy of the part of surface waves along the path Pv is partially absorbed such that a weakened output signal D1 is produced for the output signal S3 as shown in FIG. 1B, which happens at time t from which a touched position X in a horizontal axis can be obtained, wherein the depth of the output signal D1 is associated with the pressure of touch on the panel. This also allows a touched position Y in a vertical axis to be obtained. Thus, the location of point A1 can be determined by the coordinates (X, Y).

However, in the above surface acoustic wave touch panel system, since the surface waves emitted respectively from the emitting transducers T1, T2 require n times of reflections and transmissions via the reflecting gates G1, G2, G3, and G4 to reach the corresponding receiving transducers R1, R2, most of the surface wave energy from the emitting transducers T1, T2 is lost and thus the output signals S3, S4 are weakened. This is disadvantageous for the control system 11 to analyze the output signals. Moreover, in order to make the n parts of surface waves reflected by the reflecting gates G1, G3 have the same energy, the design of reflecting gates and the fabrication processes of the substrate 10 become more complex.

In addition, as the surface acoustic wave is fast and an interval between time t0 and time tn is short, a higher performance A/D converter is required to provide a faster operating speed. However, the high performance A/D converter is expensive, making the cost of the touch panel greatly raised. On the contrary, if to avoid the high cost of the touch panel, the resolution thereof must be reduced.

FIG. 2A shows a structure of a surface acoustic wave touch panel system with an array of emitting transducers and an array receiving transducers according to U.S. Pat. No. 3,673,327. As shown in FIG. 2A, in the system, a plurality of parallel emitters 21, 22 are respectively provided on two adjacent sides of a substrate 20a of the touch panel 20. A plurality of parallel receivers 23, 24 are respectively provided on the other two adjacent sides of the substrate 20 and opposed to the arrays of emitters 21, 22 respectively. That is, each of the plurality of emitters 21 corresponds to one of the plurality of receivers 23, and each of the plurality of emitters 22 corresponds to one of the plurality of receivers 24. The emitters 21, 22 create parallel surface acoustic waves 25, 26 respectively along the X-axis and Y-axis and over the touch panel 20 to form a detection matrix.

FIG. 2B is a cross-sectional view showing surface waves being applied on the touch panel 20. As shown in FIG. 2B, the emitter 21 is composed of a piezoelectric chip 21a and a synthetic transparent resin 21b, and the receiver 23 is composed of a piezoelectric chip 23a and a synthetic transparent resin 23b. In operation, a driver 27 transmits electric signals to the piezoelectric chip 21a to produce vibration such that the synthetic transparent resin 21b produces and transmits surface acoustic waves 28 along the substrate 20a to the opposed synthetic transparent resin 23b to produce vibration. The piezoelectric chip 23a converts the vibration into electric signals, and the electric signals are transmitted from the receiver 23 to a control system 30 via a signal detector 29 for signal analysis. When the user touches the substrate, this action would impede the surface waves 25, 26 transmitted over the substrate, that is, the surface wave energy would be absorbed such that the control system 30 can calculate the touched position.

However, the touch panel with an array of emitting transducers and an array of receiving transducers makes its structure relatively complex, and the resolution thereof directly relates to the signal analysis method and is the same as a pitch between adjacent transducers. Consequently, under limitation on the fabrication technology and cost, it is difficult to provide products with high resolution.

Therefore, the problem to be solved here is to provide a surface acoustic wave touch panel system with high resolution and high throughput so as to eliminate the drawbacks in the prior art.

### SUMMARY OF THE INVENTION

In light of the above drawbacks in the prior art, an objective of the present invention is to provide a surface acoustic wave touch panel and a system of the same so as to provide high resolution and high throughput.

Another objective of the present invention is to provide a surface acoustic wave touch panel and a system of the same, which have simple fabrication processes.

In order to achieve the foregoing and other objectives, the present invention provides a surface acoustic wave touch panel, comprising: a substrate; at least one first emitter and at least one second emitter formed on two adjacent edges of the substrate respectively; a first receiver and a second receiver respectively formed on edges of the substrate opposite to the edges with the first and second emitters, so as to receive emitting signals from the first and second emitters respectively, wherein the relation between the receiver number on one edge of the substrate to the emitter number on one edge of the substrate is multiple to multiple, multiple to one, or one to multiple.

The present invention also provides a system with the surface acoustic wave touch panel. The system comprises: the foregoing surface acoustic wave touch panel, an input/output (I/O) controlling unit, and a signal processing unit. The I/O controlling unit uses a multiplex scanning technique to excite the first and second emitters to emit surface acoustic waves. The first and second receivers receive the emitted surface waves from the first and second emitters and convert the received surface waves to output signals. The system further comprises a detecting unit, such that the I/O controlling unit uses the multiplex scanning technique to control the detecting unit to pick up the output signals from the first and second receivers. When a user touches a position in an active area of the substrate, the surface waves passing through the position are impeded and the energy thereof is partially absorbed, making the amplitude of the output signals reduced. The signal processing unit is used to process the output signals from the first and second receivers so as to detect any of the output signals having the reduced amplitude.

Therefore, the surface acoustic wave touch panel and the system of the same according to the present invention have advantages such as high throughput, high resolution of the touch panel, and simple fabrication processes of the touch panel.

### BRIEF DESCRIPTION OF THE DRAWINGS

The present invention can be more fully understood by reading the following detailed description of the preferred embodiments, with reference made to the accompanying drawings, wherein:

FIG. 1A (PRIOR ART) is a schematic diagram showing a structure of a conventional surface acoustic wave touch panel system;

FIG. 1B (PRIOR ART) is a graph showing the time-amplitude relation of output signals S3 of a receiving transducer R1 in FIG. 1A;

FIG. 2A (PRIOR ART) is a top view of another conventional surface acoustic wave touch panel system;

FIG. 2B (PRIOR ART) is a cross-sectional view showing surface waves being applied on the touch panel of FIG. 2A;

FIG. 3A is a top view of a surface acoustic wave touch panel according to a first embodiment of the present invention;

FIG. 3B is a top view of a surface acoustic wave touch panel according to a second embodiment of the present invention;

FIG. 3C is a top view of a surface acoustic wave touch panel according to a third embodiment of the present invention;

FIG. 3D is a top view of a surface acoustic wave touch panel according to a fourth embodiment of the present invention;

FIG. 4A is a schematic diagram showing a structure of a system with the surface acoustic wave touch panel system in FIG. 3A;

FIG. 4B is a schematic diagram showing a structure of a system with the surface acoustic wave touch panel system in FIG. 3B;

FIG. 4C is a schematic diagram showing a structure of a system with the surface acoustic wave touch panel system in FIG. 3C;

FIG. 5 is a graph showing the time history of output signals F obtained by converting and modulating surface acoustic waves and received by a single receiver 303′ in FIG. 4B;

FIG. 6 is a graph showing the time history of output signals F′ obtained by converting and modulating surface acoustic waves and received by a single receiver 304′ in FIG. 4B; and

FIG. 7 is a graph showing signals of a touched position processed and obtained by a neural network according to the surface acoustic touch panel of the present invention.

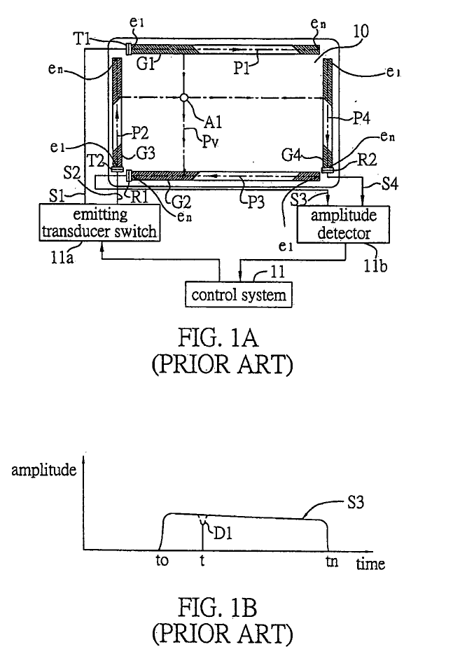

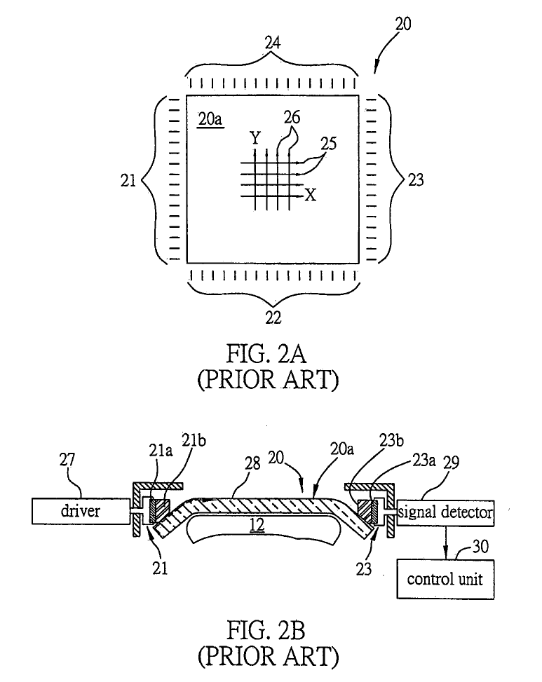

### DETAILED DESCRIPTION OF THE PREFERRED EMBODIMENT

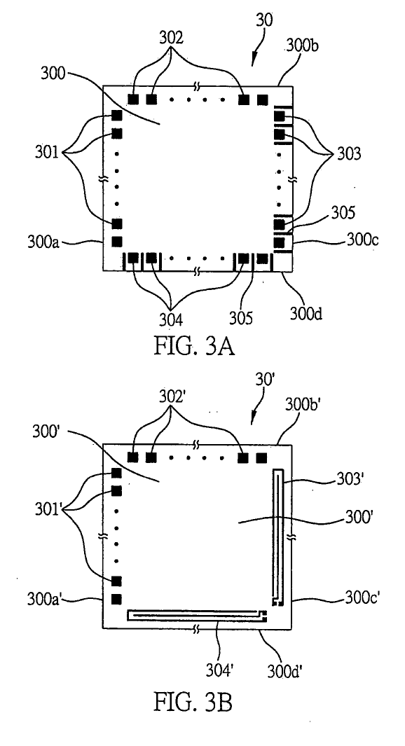

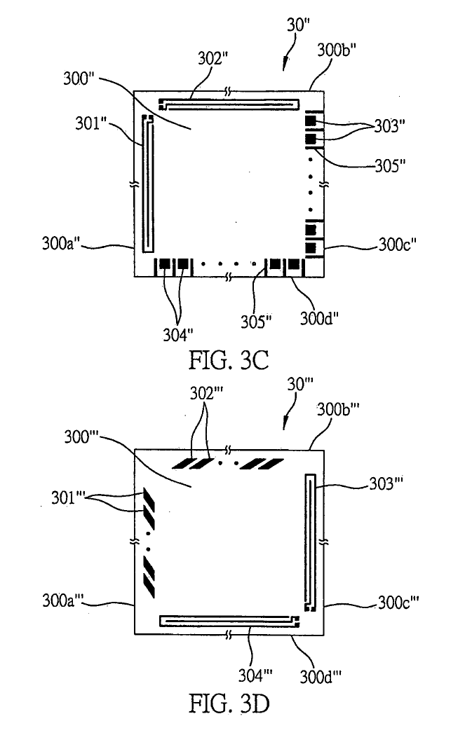

Preferred embodiments of a surface acoustic wave touch panel and a system of the same proposed in the present invention are described in detail as follows with reference to FIGS. 3 to 7.

Referring to FIG. 3A showing a top view of the surface acoustic wave touch panel according to a first embodiment of the present invention, this surface acoustic wave touch panel 30 comprises a substrate 300 having a plurality of emitters 301, 302 and a plurality of receivers 303, 304.

The substrate 300 is a thin plate, such as a transparent substrate. The plurality of emitters 301, 302 and the plurality of receivers 303, 304 are formed by depositing piezoelectric films on a surface of the substrate 300, wherein the plurality of emitters 301 are disposed sequentially as a one-dimensional array on an edge 300a of the substrate 300, and the plurality of emitters 302 are disposed sequentially as a one-dimensional array on an edge 300b of the substrate 300 adjacent to the edge 300a. The plurality of receivers 303 are arranged sequentially as a one-dimensional array on an edge 300c of the substrate 300, and the plurality of receivers 304 are arranged sequentially as a one-dimensional array on an edge 300d of the substrate 300 adjacent to the edge 300c. A narrow trench 305 is formed between any two adjacent receivers 303, 304 to eliminate interference during signal receiving. This provides a touch panel with a plurality of input terminals and a plurality of output terminals.

FIG. 3B shows a top view of the surface acoustic wave touch panel according to a second embodiment of the present invention. For the sake of simplicity in description, only the differences between this second embodiment and the above first embodiment are discussed here. As shown in FIG. 3B, in this embodiment, a plurality of emitters 301′, 302′ are formed on a substrate 300′ of the touch panel 30′, wherein the emitters 301′ are sequentially arranged on an edge 300a′ of the substrate 300′, and the emitters 302′ are sequentially arranged on an edge 300b′ of the substrate 300′ adjacent to the edge 300a′. Moreover, a strip-shaped receiver 303′ is disposed on an edge 300c′ of the substrate 300′ opposed to the edge 300a′, and a strip-shaped receiver 304′ is disposed on an edge 300d′ of the substrate 300′ opposed to the edge 300b′. This provides a touch panel with a plurality of input terminals and a single output terminal.

FIG. 3C shows a top view of the surface acoustic wave touch panel according to a third embodiment of the present invention. For the sake of simplicity in description, only the differences between this third embodiment and the above first and second embodiments are discussed here. As shown in FIG. 3C, in this embodiment, a strip-shaped emitter 301″ is disposed on an edge 300a″ of a substrate 300″ of the touch panel 30″, and a strip-shaped emitter 302″ is disposed on an edge 300b″ of the substrate 300″ adjacent to the edge 300a″. A plurality of receivers 303″ are sequentially arranged on an edge 300c″ of the substrate 300″, and a plurality of receivers 304″ are sequentially arranged on an edge 300d″ of the substrate 300″. A narrow trench 305″ is formed between any two adjacent receivers 303″, 304″ to eliminate interference during signal receiving. This provides a touch panel with a single input terminal and a plurality of output terminals.

FIG. 3D shows a top view of the surface acoustic wave touch panel according to a fourth embodiment of the present invention. This fourth embodiment differs from the above first, second, and third embodiments in that a touch panel 30″′ is provided having a plurality input terminals and a single output terminal and having smooth and continuous output signals. As shown in FIG. 3D, in this embodiment, a plurality of emitters 301″′, 302″′ are parallelogram in shape and disposed on the substrate 300″′ of the touch panel 30″′. The parallelogram-shaped emitters 301″′ are arranged sequentially on an edge 300a″′ of the substrate 300″′, and the emitters 302″′ are arranged sequentially on an edge 300b″′ of the substrate 300″′ adjacent to the edge 300a″′. A strip-shaped receiver 303″′ is formed on an edge 300c″′ of the substrate 300″′ opposed to the edge 300a″′, and a strip-shaped receiver 304″′ is formed on an edge 300d″′ of the substrate 300″′ opposed to the edge 300b″′. Due to the parallelogram shape and the sequential arrangement of the emitters 301″′, 302″′, signals emitted from the emitters 301″′, 302″′ may partially overlap such that the receivers 303″′, 304″′ would receive relatively more smooth and continuous signals from the emitters 301″′, 302″′.

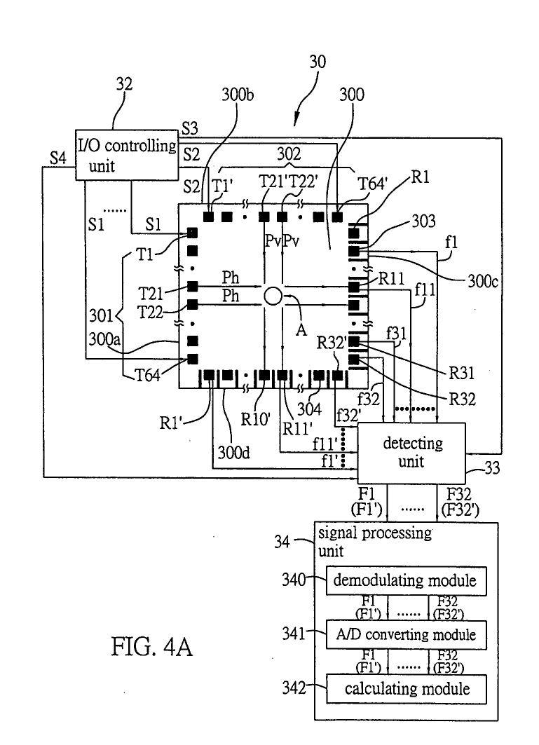

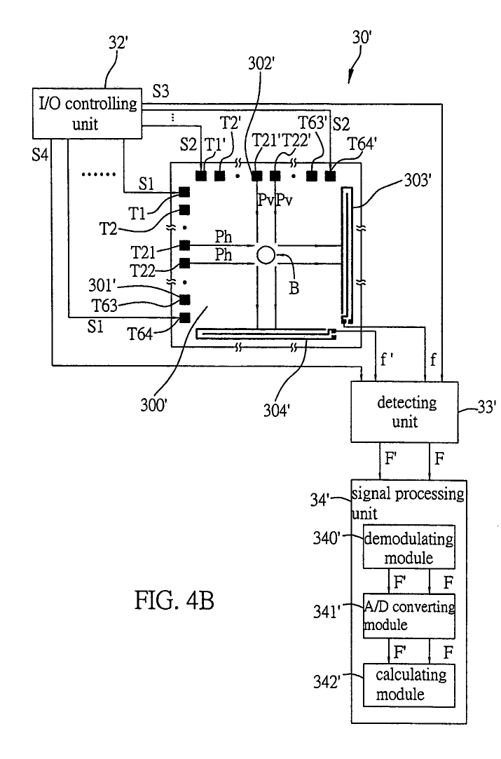

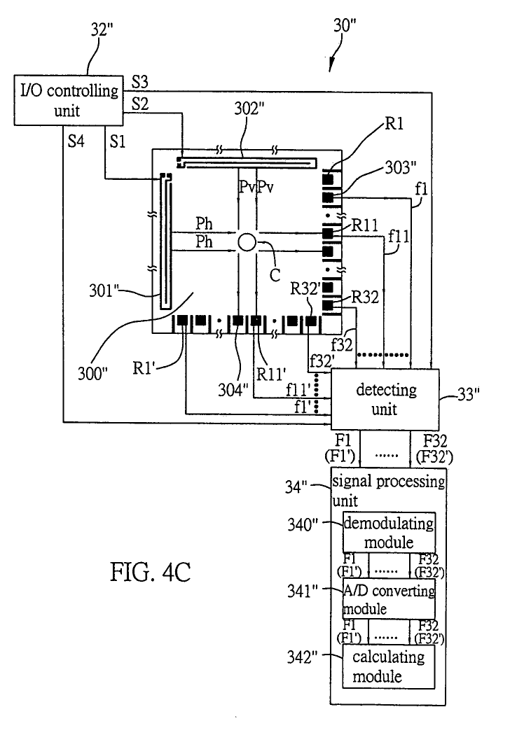

FIG. 4A shows a system applied with the surface acoustic wave touch panel 30 according to the first embodiment of the present invention. As shown in FIG. 4A, the system comprises the surface acoustic wave touch panel 30, an I/O (input/output) controlling unit 32, a detecting unit 33, and a signal processing unit 34.

The surface acoustic wave touch panel 30 is integrated in a display device (not shown) and is formed by an arrangement described above with reference to FIG. 3A, thereby not to be further repeated here.

The I/O controlling unit 32 is used to excite the emitters 301, 302 by multiplex scanning such that the emitters 301, 302 emit surface acoustic waves. The plurality of receivers 303, 304 receive the surface acoustic waves transmitted from the emitters 301, 302 and over the substrate 300 and convert the received surface acoustic waves into output signals.

The detecting unit 33 is used to pick up the output signals from the receivers 303, 304 and amplify the output signals. As the output signals from the receivers 303, 304 are high frequency signals for example carrier signals of 20 MHz, the amplifying process is necessary for the output signals such that the signal processing unit 34 can perform a subsequent treatment such as demodulation on the output signals from the receivers 303, 304.

The signal processing unit 34 is used to process the amplified output signals from the detecting unit 33 by a neural network. The signal processing unit 34 comprises a demodulating module 340, an A/D converting module 341, and a calculating module 342. The resolution of the surface acoustic wave touch panel 30 depends on the number of receivers 303, 304 and the structure of neural network.

The number of receivers 303, 304 is not necessarily equal to the number of emitters 301, 302. As shown in FIG. 4A, for the sake of simply describing the present invention, only sixty four one-dimensional emitters 301 are provided and labeled from T1 to T64, and sixty four one-dimensional emitters 302 are provided and labeled from T1′ to T64′; thirty two one-dimensional receivers 303 are provided and labeled from R1 to R32, and thirty two one-dimensional receivers 304 are provided and labeled from R1′ to R32′. The Y axis is defined along the direction of the edge 300a of the substrate 300, and the X axis is defined along the direction of the edge 300d of the substrate 300. It should be noted that the definition of X and Y axes is not limited to this manner but can depend on the practical requirement.

The I/O controlling unit 32 provides a signal S1 to excite the emitters T1 to T64 in a multiplex manner to emit surface acoustic waves, and provides a signal S2 to excite the emitters T1′ to T64′ in a multiplex manner to emit surface acoustic waves. The receivers R1 to R32 receive the surface acoustic waves from the emitters T1 to T64 and convert the received surface acoustic waves to output signals f1 to f32. The receivers R1′ to R32′ receive the surface acoustic waves from the emitters T1′ to T64′ and convert the received surface acoustic waves to output signals f1′ to f32′.

The detecting unit 33 amplifies the output signals f1 to f32 and f1′ to f32′ from the receivers R1 to R32 and R1′ to R32′, and transmits the amplified output signals F1 to F32 and F1′ to F32′ to the signal processing unit 34. Referring to FIG. 4A, as there are multiple receivers 303, 304 respectively provided on two adjacent edges of the touch panel 30, the detecting unit 33 in this embodiment further has a function of multiplexer, which can receive the output signals f1 to f32 and f1′ to f32′ from all the receivers 303, 304 simultaneously or in a multiplex manner according to signals S3, S4 transmitted from the I/O controlling unit 32. The multiplex manner performed by the detecting unit 33 can be flexibly designed according to hardware resources.

The demodulating module 340 uses an envelope detection method to demodulate the amplified output signals F1 to F32 and F1′ to F32′ from the detecting unit 33. With multiple receivers 303, 304 being provided on the touch panel 30, a plurality of envelope signals are produced after demodulation by the demodulating module 340. According to a condition of the substrate 300 being touched, the receivers 303, 304 would receive the surface acoustic waves of different degrees from the emitters 301, 302. As shown in FIG. 4A, the signals S1, S2 excite the emitters T1 to T64 and T1′ to T64′ to emit surface acoustic waves along the surface of the substrate 300. When point A on the substrate 300 is touched by a user, energy of the surface acoustic waves is partly absorbed. The receivers R1 to R32 and R1′ to R32′ receive the surface acoustic waves and convert them to output signals f1 to f32 and f1′ to f32′, and the detecting unit 33 picks up the output signals f1 to f32 and f1′ to f32′ from the receivers R1 to R32 and R1′ to R32′ according to the signals S3, S4. As a result, the detecting unit 33 amplifies the output signals f1 to f32 and f1′ to f32′ to be amplified output signals F1 to F32 and F1′ to F32′, and the signal processing unit 34 detects different envelopes from the amplified output signals F1 to F32 and F1′ to F32′. In this embodiment, with sixty-four receivers R1 to R32 and R1′ to R32′ being provided, sixty-four amplified output signals F1 to F32 and F1′ to F32′ are produced and subjected to the envelope detection process. The A/D converting module 341 samples the detected envelopes and converts them to digital signals, wherein each sampling procedure generates a set of digital codes that are stored in a memory device (such as RAM, not shown). The calculating module 342 can calculate and determine the position of the touched point A on the substrate 300 by the neural network according to the digital codes stored in the memory device. It should be noted that the operating mechanism and method of the calculating module 342 using the neural network to determine the position of point A are conventional in the art and not to be further described herein.

Therefore, in this embodiment, the touch panel 30 is able to calculate the touched position thereof according to relation between the intensity of received signals and spatial locations in the case with multiple receivers being respectively provided on two adjacent edges of the touch panel 30.

FIG. 4B shows a system applied with the surface acoustic wave touch panel 30′ according to the second embodiment according to of the present invention. This embodiment of FIG. 4B is similar in working principles to the above embodiment of FIG. 4A. Thus only the differences between this embodiment and the above embodiment are described below for the sake of simplicity.

The I/O controlling unit 32′ produces a signal S1 to excite the emitters T1 to T64 sequentially in a multiplex manner to emit surface acoustic waves, and also produces a signal S2 to excite the emitters T1′ to T64′ sequentially in a multiplex manner to emit surface acoustic waves respectively. The single receiver 303′ and the single receiver 304′ receive the surface acoustic waves from the emitters T1 to T64 and the emitters T1′ to T64′ and convert the received surface acoustic waves into output signals f, f′. The detecting unit 33′ picks up the output signals f, f′ from the receivers 303′, 304′ according to signals S3, S4 transmitted from the I/O controlling unit 32′. In this embodiment, as a single receiver 303′, 304′ is respectively provided on two adjacent edges of the touch panel 30′, the detecting unit 33′ has a function of multiplexer as the detecting unit 33 of FIG. 4A to amplify the output signals f, f′ transmitted from the receivers 303′, 304′ and sequentially transmit amplified output signals F, F′ to the signal processing unit 34′. In this embodiment, the operating principles of the demodulating module 341′, A/D converting module 341′ and calculating module 342′ of the signal processing unit 34′ are substantially the same as those shown in FIG. 4A. The only difference is in that as only a single receiver 303′, 304′ is provided respectively on two adjacent edges of the touch panel 30′, the signal processing unit 34′ performs the envelope detection process on the amplified output signals F, F′ to detect an envelope, sample the envelope, and convert the envelope for storage. Therefore, in this embodiment, the touch panel 30′ is able to calculate the touched position thereof according to the time history of received signals in the case with a single receiver being respectively provided on two adjacent edges of the touch panel 30′.

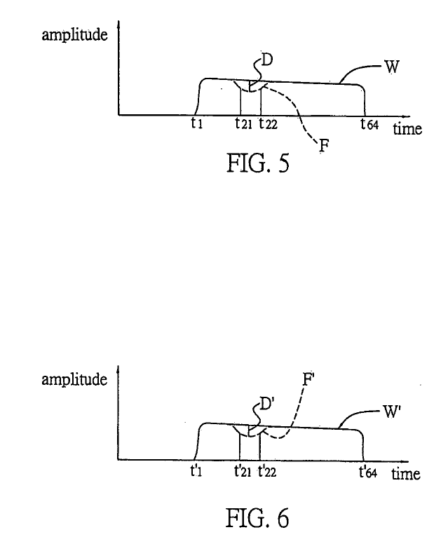

FIGS. 5 and 6 are graphs respectively showing the time history of output signals F, F′ obtained by modulating surface acoustic waves and received by a single receiver. As shown in the drawings, the solid line indicates an output signal W, W′ from the single receiver 303′, 304′ receiving the surface acoustic waves emitted from the emitters T1 to T64 and T1′ to T64′ when the touch panel 30′ is not touched by the user. When the user touches point B on the substrate 300′, energy of the surface acoustic waves emitted from the emitters T1 to T64 and T1′ to T64′ is partly absorbed, making the detecting unit 33′ pick up the output signals f, f′ from the receivers 303′, 304′ according to the signals S3, S4 transmitted from the I/O controlling unit 32′. Then, the signal processing unit 340′ detects different envelopes according to the amplified output signals F, F′ from the detecting unit 33′. In this embodiment, in case of sampling time t1 to t64 and t1′ to t64′ being set, a reduced signal D, D′ is produced by sampling the envelopes during time t21 to t22 and t21′ to t22′ respectively for the amplified output signals F, F′. The calculating module 342′ determines a Y-axis coordinate of the point B by the neural network according to the time t21 to t22 where the reduced signal D for the amplified output signal F is produced. The calculating module of 342′ also determines an X-axis coordinate of the point B by the neural network according to the time t21′ to t22′ where the reduced signal D′ of the amplified output signal F′ is produced. Thus, the X-axis and Y-axis coordinates of the point B are obtained.

FIG. 4C shows a system applied with the surface wave touch panel 30″ according to the present invention. This system of FIG. 4C is integrated with a display device (not shown) and is similar in working principles to those of FIGS. 4A and 4B. Thus only the differences between this embodiment and the above embodiments are described below for the sake of simplicity.

The I/O controlling unit 32″ produces a signal S1 to excite the single emitter 301″ to emit a surface acoustic wave, and produces a signal S2 to excite the single emitter 302″ to emit a surface acoustic wave. The receivers R1 to R32 and R1′ to R32′ receive the surface acoustic wave emitted from the single emitter 301″ and convert the received surface acoustic wave into output signals f1 to f32 and f1′ to f32′. The detecting unit 33″ picks up the output signals f1 to f32 and f1′ to f32′ according to signals S3, S4 transmitted from the I/O controlling unit 32″.

As shown in FIG. 4C, the signal S1, S2 excites the single emitter 301″, 302″ to emit the surface acoustic wave along the surface of the substrate 300″, when point C on the substrate 300″ is touched by the user, energy of the surface acoustic wave is partly absorbed, making the detecting unit 33″ pick up the output signals f1 to f32 and f1′ to f32′ from the receivers R1 to R32 and R1′ to R32′ according to the signals S3, S4 transmitted from the I/O controlling unit 32″, such that the detecting unit 33″ amplifies the output signals f1 to f32 and f1′ to f32′ in a multiplex manner. Similarly to the technology shown in FIG. 4A, the signal processing unit 34″ in this embodiment detects envelopes, samples the envelopes, and converts the envelopes to be stored according to amplified output signals F1 to F32 and F1′ to F32′ from the detecting unit 33″, such that the position of the touched point C on the substrate 300″ can be calculated by the neural network.

In the surface acoustic wave touch panel and the system of the same according to the present invention, the calculating modules (342, 342′, and 342″) of the foregoing signal processing units (34, 34′, and 34″) use the neural network to determine the touched position on the touch panel. The method for obtaining the touched position is described below with reference to FIG. 4B.

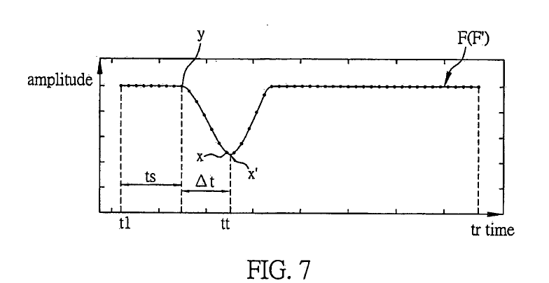

FIG. 7 is a graph showing the time-amplitude relation of the amplified output signal F, F′ demodulated by the demodulating module 340′ of the signal processing unit 34′ when point B on the touch panel 30′ is touched by the user as shown in FIG. 4B. As shown in FIG. 7, t1 represents the signal initiating time, tr represents the signal finishing time, and tt represents the time relatively close to the lowest position of a signal trough region. The signal processing unit 34′ processes signals so as to obtain the time tt for position x′ relatively close to the lowest position. The calculating module 342′ of the signal processing unit 34′ uses the neural network to process sampled signals from the amplified output signal F, F′ to obtain the time tt. First, the sampled signals are compared in intensity to select a sampled signal with the lowest intensity, for example selecting point x in FIG. 7 acting as a first interpolating point. The signal processing unit 34′ selects n points rightwards and leftwards respectively from the point x relatively close to the lowest position. In this embodiment, n can be 6, such that 2n+1 points (13 points in this embodiment) are selected from the signal trough region. The signal processing unit 34′ selects point y as a basis of time series corresponding to the 2n+1 points and obtains a comparison time period ts thereof during the processing time of the amplified output signal F, F′. However, if the above point x is not the lowest position, for example, if among the selected 2n+1 points, position x′ located at the left side of the point x has lower signal intensity than that of the point x, such position x′ can be obtained using the surface acoustic wave touch panel of the present invention and the neural network. That is, the neural network estimates a time difference Δt between the position x′ (closer to the lowest position than the point x) and the point y according to the signals corresponding to the 2n+1 points. The calculating module 342′ of the signal processing unit 34′ adds the time period ts and the time difference Δt to calculate the time tt corresponding to the position x′ relatively close to the lowest position so as to determine the Y-axis or X-axis coordinate of the point B. This allows the coordinates of the touched point B on the touch panel 30′ to be rapidly and precisely obtained according to the relation between the intensity of sampled signals and time.

As a plurality of receivers are provided respectively on two adjacent edges of the touch panel shown in FIG. 4A or 4C, relatively more envelope signals are obtained after demodulation by the demodulating module, such that different envelopes of the output signals of the receivers can be detected according to a practical touch-control condition. Peak detection, conversion and storage processes are performed on the different envelopes of the output signals, and the calculating module is able to use the neural network to precisely determine the touched position of the touch panel according to the stored envelopes of the output signals and locations of the corresponding receivers.

The surface acoustic wave touch panel in the present invention controls the plurality of array-arranged receivers and emitters by multiplex scanning such that the time history and duration of a surface acoustic wave emitted from each of the emitters can be controlled and the delay time of picking up an output signal from each of the receivers can also be controlled, such that an expensive A/D converter is not required during signal processing. Further, by calculation via the neural network, even if only a single emitter or a single receiver is provided an edge of the touch panel, the touched position of the touch panel can also be determined, thereby reducing the cost of the touch panel. Moreover, the surface acoustic wave touch panel and the system of the same according to the present invention use the neural network to process signals such that the resolution and throughput are improved.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A system of surface acoustic wave touch panel, comprising:
a surface acoustic wave touch panel with a substrate, wherein at least one first emitter and at least one second emitter are formed on two adjacent edges of the substrate respectively, and at least one first receiver and at least one second receiver are respectively provided on edges of the substrate opposed to the edges with the first and second emitters, and wherein relation between the receiver number on one edge of the substrate to the emitter number on one edge of the substrate is multiple to multiple, multiple to one, or one to multiple;
an input/output (I/O) controlling unit for exciting the first and second emitters in a multiplex manner to emit surface acoustic waves, wherein the first and second receivers receive the surface acoustic waves emitted from the first and second emitters and convert the received surface acoustic waves into output signals, and when a particular position on the substrate of the touch panel is touched, the surface acoustic waves passing through this position are impeded and energy thereof is partially absorbed, making amplitude of the output signals reduced; and
a signal processing unit for processing the output signals from the first and second receivers via a neural network to detect any of the output signals having reduced amplitude so as to determine coordinates of the touched position on the touch panel.

2. The system of claim 1, wherein the signal processing unit further comprises:
a demodulating module for performing envelope detection on the output signals from the first and second receivers so as to output envelope signals;
an A/D converting module for sampling the envelope signals from the demodulating module and converting the sampling results into digital signals; and
a calculating module for processing the digital signals via the neural network to determine the coordinates of the touched position on the touch panel.

3. The system of claim 1, further comprising a detecting unit controlled by the I/O controlling unit to pick up the output signals from the first and second receivers in a multiplex manner, and for amplifying the output signals.

4. The system of claim 3, wherein when the relation between the receiver number on one edge of the substrate to the emitter number on an opposite edge of the substrate is multiple to multiple or multiple to one, the detecting unit amplifies the output signals from the first and second receivers in a multiplex manner and transmits the amplified output signals to the signal processing unit.

5. The system of claim 1, wherein the 1/O controlling unit controls duration of the exciting time for the first and second emitters.

6. The system of claim 1, wherein when the relation between the receiver number on one edge of the substrate to the emitter number on an opposite edge of the substrate is one to multiple, the signal processing unit determines the touched position on the touch panel via the neural network and according to relation between intensity and time of the output signals from the first and second receivers.

7. The system of claim 1, wherein when the relation between the receiver number on one edge of the substrate to the emitter number on an opposite edge of the substrate is multiple to multiple or multiple to one, the signal processing unit determines the touched position on the touch panel via the neural network and according to relation between intensity and spatial locations of the output signals from the first and second receivers.

8. The system of claim 1, wherein if two or more of the emitters or receivers are provided on one edge of the substrate, the two or more emitters or receivers are arranged as an array on the corresponding edge of the substrate.

9. The system of claim 8, wherein at least one trench is provided between two adjacent ones of the receivers to eliminate interference during signal receiving.

10. The system of claim 1, wherein if only one of the emitter or receiver is provided on one edge of the substrate, the single emitter or receiver is shaped as a strip on the corresponding edge of the substrate.

11. The system of claim 1, wherein the first and second emitters are substantially shaped as parallelogram on the edges of the substrate.

12. A surface acoustic wave touch panel, comprising:
a substrate;
at least one first emitter and at least one second emitter respectively formed on two adjacent edges of the substrate; and
at least one first receiver and at least one second receiver respectively made of piezoelectric films and respectively formed on edges of the substrate opposed to the edges with the first and second emitters, the first and second receivers being provided for receiving signals emitted from the first and second emitters, wherein relation between the receiver number on one edge of the substrate to the emitter number on one edge of the substrate is multiple to multiple, multiple to one, or one to multiple.

13. The surface acoustic wave touch panel of claim 12, wherein if two or more of the emitters or receivers are provided on one edge of the substrate, the two or more emitters or receivers are arranged as an array on the corresponding edge of the substrate.

14. The surface acoustic wave touch panel of claim 13, wherein at least one trench is provided between two adjacent ones of the receivers to eliminate interference during receiving of the signals.

15. The surface acoustic wave touch panel of claim 12, wherein if only one of the emitter or receiver is provided on one edge of the substrate, the single emitter or receiver is shaped as a strip on the corresponding edge of the substrate.

16. The surface acoustic wave touch panel of claim 12, wherein the first and second emitters are substantially shaped as parallelogram on the edges of the substrate.
